(19) United States
(12) Patent Application Publication
(10) Pub. No.: US 2007/0014209 A1
(43) Pub. Date: Jan. 18, 2007

(54) Method and circuit for protecting optical pickup actuator

(76) Inventor: Young-hoon Lee, Seoul (KR)

Correspondence Address: LEE & MORSE, P.C., 3141 FAIRVIEW PARK DRIVE, SUITE 500, FALLS CHURCH, VA, 22042, US

(21) Appl. No.: 11/486,076

(22) Filed: Jul. 14, 2006

(30) Foreign Application Priority Data
Jul. 14, 2005 (KR) 10-2005-0063756

(51) Int. Cl. G11B 7/00

(52) U.S. Cl. 369/44.29

(57) ABSTRACT

A method for protecting an optical pickup actuator includes generating an abnormal control signal using signals used to control focusing and tracking, and generating a protection command signal using the abnormal control signal, the protection command signal instructing protection of the optical pickup actuator by determining whether control of focusing and tracking of the optical pickup actuator is normal.

### BACKGROUND OF THE INVENTION

1. Field of the Invention

The present invention relates to an optical pickup unit. More particularly, the present invention relates to a method and circuit for protecting an optical pickup actuator.

2. Description of the Related Art

Optical pickup units may be used to store data on an optical disk or read data stored on the optical disk. The optical pickup unit may include an optical pickup actuator. Information may be recorded on or read out from the optical disk through focusing and tracking operations performed by the optical pickup actuator.

The focusing operation may adjust a distance between the optical disk and a lens as the optical disk rotates while the optical pickup unit reads the data stored in the optical disk. To adjust the distance with respect to the optical disk, the lens may be attached to the optical pickup actuator, which may be moved up and down with respect to the surface of the optical disk.

The tracking operation may maintain the focus of the lens in line with a normal track by translating the lens, e.g., left and right, when the focus of the lens deviates from the track where data is stored.

The focusing and tracking operations of the optical pickup actuator may be achieved by appropriately adjusting an electromagnetic force generated by the interaction between a plurality of electromagnets and coils in the optical pickup actuator. The electromagnetic force may vary at a particular rate according to the amount of current flowing in the coil. The amount of current may be controlled by the focusing and tracking operations performed by the optical pickup actuator.

The focusing and tracking operations that are normally performed may restore normal operation after occurrence of an operational error of the optical pickup actuator within a particular range. In some cases, however, the focusing of a lens and the tracking of an optical disk are not available. For example, problems may occur when an optical disk having an abnormal surface is inserted into an optical disk driver, or the position of the optical disk is moved by a considerable physical impact applied to the optical disk drive. In these cases, since the distance between the surface of the optical disk and the lens is too short or too far, the normal distance cannot be restored within a particular time period, or since the focus of the lens is too far from the track of the optical disk, the focus cannot be restored to the position of the track within a particular time period.

When the abnormal state in which the data reading is initially impossible or an error occurs is returned to a normal operation range, a controller increases the amount of current flowing in the coil of the optical pickup actuator to adjust the focus or trace the track.

Since the focusing and tracking operations performed by the optical pickup actuator should be precise and sensitively react to the current, the coil is precisely manufactured corresponding to such operations. When excessive current flows in the coil for a long time, the coil may be physically and electrically damaged. If the coil is damaged so as not to recover electrical features of the coil, the optical pickup actuator can no longer be used.

A microcontroller may be used as a controller to detect a situation in which the coil is likely to be physically and electrically damaged and take appropriate actions. That is, the microcontroller may monitor a situation in which the coil is likely to be electrically damaged, and may prevent the damage. When a situation which may damage the coil is detected, the microcontroller may prevent excessive current from flowing in the coil of the optical pickup actuator. However, it is a considerable burden to the microcontroller, which controls all operations of the optical disk drive, to also monitor the drive signal and the tracking signal, and accordingly take action to protect the optical pickup actuator.

As another method to solve the above problem, a drive integrated circuit (IC) for controlling the operation of the optical pickup actuator may monitor a particular drive signal provided to the optical pickup actuator to prevent the coil from being irrecoverably damaged due to the excessive current applied to the coil. In this case, when the drive IC is designed, it is inconvenient to initially consider a circuit capable of detecting the situation. Furthermore, since the conditions to monitor an optical pickup actuator's abnormal operation situation and a method for protecting the optical pickup actuator corresponding thereto are fixed by the initial design, when a user requests different monitoring conditions and/or change of the protection method, the circuit design of the driver IC needs to be done from scratch.

### SUMMARY OF THE INVENTION

The present invention is therefore directed to an apparatus and method of protecting an optical pickup actuator, which substantially overcome one or more of the problems due to the limitations and disadvantages of the related art.

It is therefore a feature of an embodiment of the present invention to provide a method for protecting an optical pickup actuator by which a user can control the time and/or amount of current provided to the optical pickup actuator to prevent excessive current from flowing in the coil of the optical pickup actuator for an excessive period of time.

It is therefore another feature of an embodiment of the present invention to provide a computer-readable recording medium in which functions to protect the optical pickup actuator are stored in a predetermined language so as to be performed by a computer or a controller.

It is therefore yet another feature of an embodiment of the present invention to provide a circuit for protecting an optical pickup actuator which implements the optical pickup actuator protection method.

At least one of the above and other features and advantages of the present invention may be realized by providing a method for protecting an optical pickup actuator including generating an abnormal control signal using signals used to control focusing and tracking of the optical pickup actuator, and generating a protection command signal using the abnormal control signal, the protection command signal instructing protection of the optical pickup actuator by determining whether control of focusing and tracking of the optical pickup actuator is normal.

A focus error signal and a tracking error signal may be used for the generation of the abnormal control signal. A focus control signal generated from a focus error signal and a tracking control signal generated from a tracking error signal may be used for the generation of the abnormal control signal.

The generation of the protection command signal may include comparing an absolute value of a voltage level of the abnormal control signal with an absolute value of a detection voltage level, wherein the detection voltage level indicates the minimum voltage level to detect a case in which focusing operation and tracking operation is abnormal, and comparing a duration time which the absolute value of the voltage level of the abnormal control signal is greater than the absolute value of the detection voltage level with a detection time range, wherein the detection time range indicates the minimum time interval to detect a case in which abnormal focusing operation and abnormal tracking operation may damage the optical pickup actuator.

At least one of the above an other features and advantages of the present invention may be realized by providing a computer-readable recording medium containing a program to be processed by a computer or a controller performs following functions of generating an abnormal control signal using signals used to control focusing and tracking of an optical pickup actuator, determining whether an absolute value of a voltage level of the abnormal control signal is greater than an absolute value of a detection voltage level, determining whether a duration time which the absolute value of the voltage level of the abnormal control signal is greater than the absolute value of the detection voltage level exceeds a detection time range, and generating a signal to instruct protection of the optical pickup actuator when the duration time exceeds the detection time range.

At least one of the above an other features and advantages of the present invention may be realized by providing a circuit for protecting an optical pickup actuator including an abnormal control signal generation unit, which generates an abnormal control signal using signals used to control focusing and tracking of the optical pickup actuator, and a protection determination unit which generates a protection command signal that instructs protection of the optical pickup actuator by determining whether focusing operation and tracking operation of the optical pickup actuator is normal, using the abnormal control signal.

The abnormal control signal may be generated using a focus error signal and a tracking error signal. The abnormal control signal may be generated using a focusing control signal generated from a focus error signal and a tracking control signal generated from a tracking error signal.

The protection determination unit may include a first determination unit outputting a first determination signal by determining whether an absolute value of a voltage level of the abnormal control signal is greater than an absolute value of a detection voltage level, a second determination unit outputting a second determination signal by determining whether a duration time which the absolute value of the voltage level of the abnormal control signal is greater than the absolute value of the detection voltage level exceeds the detection time range, and a protection command signal generation unit outputting the protection command signal using the first determination signal and the second determination signal.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a waveform diagram of an abnormal control signal and a protection command signal according to an embodiment of the present invention;

FIG. 2 illustrates a flow chart of a method for protecting an optical pickup actuator according to an embodiment of the present invention;

FIG. 3 illustrates a block diagram of a circuit for protecting an optical pickup actuator according to an embodiment of the present invention;

FIG. 4 illustrates a block diagram of an application circuit using the optical pickup actuator protection circuit according to an embodiment of the present invention; and

FIG. 5 illustrates a block diagram of an application circuit using the optical pickup actuator protection circuit according to an embodiment of the present invention.

### DETAILED DESCRIPTION OF THE INVENTION

Korean Patent Application No. 10-2005-0063756, filed on Jul. 14, 2005, in the Korean Intellectual Property Office, and entitled: “Method and Circuit for Protecting Optical Pickup Actuator,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

To read out data from an optical disk, a focus of an objective lens must be precisely controlled, and an actuator must precisely trace a track of the optical disk. A focus error signal and a tracking error signal may be used to determine whether these operations are normally performed. An optical pickup actuator control system may control up/down movement of the objective lens using a focus control signal or a driver signal generated with reference to the focus error signal. The optical pickup actuator control system may control left/right movement of the objective lens using a tracking control signal or a driver signal generated with reference to the tracking error signal. Thus, the control of the optical pickup actuator can be easily checked by monitoring the focus control signal and the tracking control signal.

In a method for protecting an optical pickup actuator according to an embodiment of the present invention, whether the optical pickup actuator is protected may be determined using an abnormal control signal which may be generated using the focus error signal and the tracking error signal. The abnormal control signal may be generated using the focus control signal and the tracking control signal, which may be generated using the focus error signal and the tracking error signal, respectively. The abnormal control signal thus may have information with respect to the normal operation and the abnormal operation of focusing and tracking.

Although in the following description the abnormal control signal is generated using the focus error signal and the tracking error signal, alternatively, the abnormal control signal may be generated using the focus control signal and the tracking control signal. Also, regardless of name, any signal generated using the focus error signal and the tracking error signal may be used to generate the abnormal control signal.

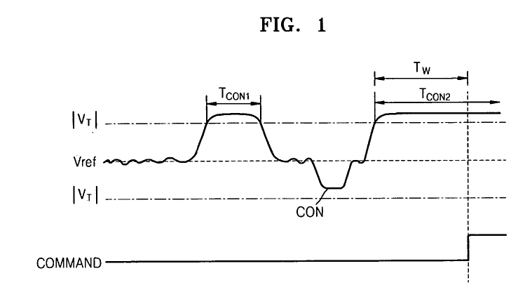

FIG. 1 illustrates a waveform diagram of an abnormal control signal and a protection command signal according to an embodiment of the present invention. Referring to FIG. 1, focusing and tracking may be performed in a section where an abnormal control signal CON shows a slight difference from a reference voltage Vref, which signifies that a small amount of current needs to be provided to a coil driving the objective lens of the optical pickup actuator. In other words, for the focusing and tracking in a section where the abnormal control signal CON has a higher voltage level or a lower voltage level than the reference voltage Vref, a considerable amount of current needs to be provided to the coil that drives the objective lens of the optical pickup actuator.

In first and second time periods T_{CON1} and T_{CON2}, during which the absolute value |V_{CON}| of a voltage level of the abnormal control signal CON exceeds the absolute value |V_{T}| of a detection voltage level, excessive current may flow in the coil of the optical pickup actuator. However, since time periods in which the voltage level of the abnormal control signal CON exceeds the detection voltage level |V_{T}| are not always problematic, in the present invention, a detection time range T_{W} is introduced. The detection time range T_{W} is the minimum time section in which the excessive current flowing in the coil of the optical pickup actuator is bearable, i.e., will not irreversibly damage the coil.

In the first time period T_{CON1}, the abnormal control signal CON is returned to the original state within the detection time range T_{W}. However, in the second time period T_{CON2}, the abnormal control signal CON is present for longer than the detection time range T_{W}. Thus, the coil of the optical actuator may be damaged during the second time period T_{CON2}, so a protection command signal COMMAND may be output after the detection time range T_{W} has been exceeded.

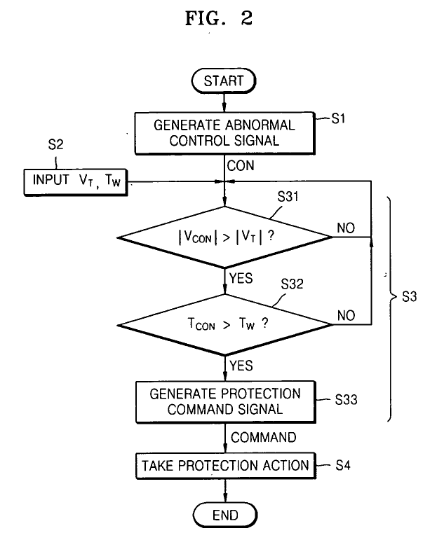

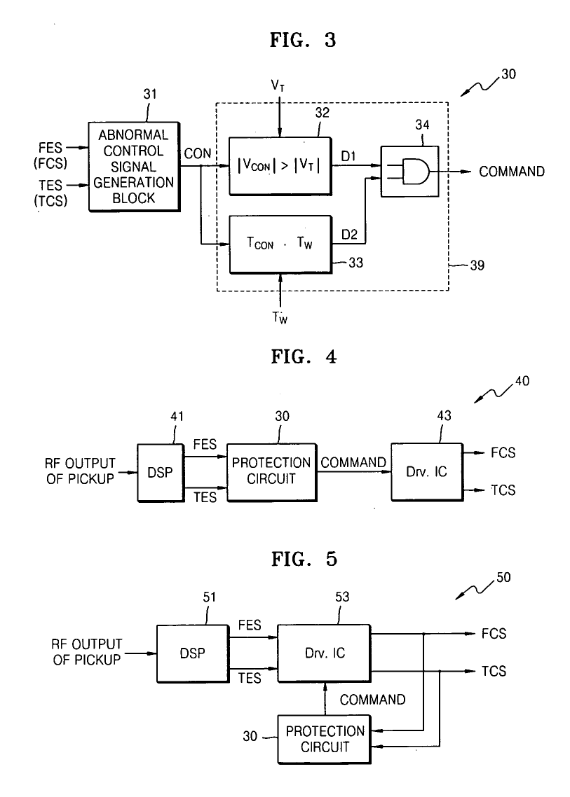

FIG. 2 illustrates a flow chart of a method for protecting an optical pickup actuator according to an embodiment of the present invention. Referring to FIG. 2, the method for protecting an optical pickup actuator may include generating an abnormal control signal (S1), inputting a detection voltage level and a detection time range (S2), generating a protection command signal (S3), and taking an action to protect an optical pickup actuator (S4). FIG. 3 illustrates a block diagram of a circuit for generating the protection command signal, and FIGS. 4 and 5 illustrate block diagrams of circuits for protecting the optical pickup actuator according to embodiments of the present invention.

In the step of generating an abnormal control signal (S1), an abnormal control signal CON may be generated using a focus error signal FES of FIG. 3 and a tracking error signal TES of FIG. 3. Not only the focus error signal FES and the tracking error signal TES, but any signals that are used to control focusing and tracking, regardless of the name and type of the signals, may be used in generating the abnormal control signal CON.

In the step of inputting a detection voltage level and a detection time range (S2), the detection voltage level V_{T} that indicates the minimum voltage level to detect a state in which focusing and tracking are abnormal and the detection time range T_{W} that indicates the minimum time period to detect a duration time in which focusing and tracking are abnormal may be input.

The detection voltage level V_{T} and the detection time range T_{W}, which are values that can be arbitrarily set and input by a user, may be stored in a predetermined storage device capable of inputting and outputting. Further, a plurality of preset detection voltage levels V_{T} and the detection time ranges T_{W} may be provided, e.g., in a look-up table, which may then be selected by a user.

Any storage device, e.g., a register or a non-volatile memory, which can be included in a controller for controlling the optical pickup actuator may be used. In some cases, the storage device may be included in the optical pickup actuator controller when it is initially designed.

The step of generating a protection command signal (S3) may include two determination steps S31 and S32, and a step of generating a protection command signal S33. In the first determination step S31, whether the absolute value |V_{CON}| of the voltage level of the abnormal control signal CON is greater than the absolute value |V_{T}| of the detection voltage level is determined. If the absolute value |V_{CON}| of the voltage level of the abnormal control signal CON is not greater than the absolute value |V_{T}| of the detection voltage level, the first determination step S31 is repeated.

If the absolute value |V_{CON}| of the voltage level of the abnormal control signal CON is greater than the absolute value |V_{T}| of the detection voltage level, the second determination step S32 may determine whether a time period T_{CON} in which the absolute value |V_{CON}| of the voltage level of the abnormal control signal CON is greater than the detection voltage level |V_{T}| of the detection voltage level exceeds the detection time range T_{W}. If the time period T_{CON} does not exceed the detection time range T_{W}, the first determination step S31 is performed.

If the time period T_{CON} exceeds the detection time range T_{W}, in the step of generating a protection command signal S33, the protection command signal COMMAND is output.

In the step of taking an action to protect an optical pickup actuator (S4), an action to protect the optical pickup actuator is taken in response to the output protection command signal COMMAND. There are a variety of methods that may be used to protect the optical pickup actuator, as discussed below in connection with FIGS. 4 and 5. For example, the optical pickup actuator may be protected by cutting off the current applied to the coil of the optical pickup actuator by controlling a driver integrated circuit (IC) that drives the optical pickup actuator. Also, the operation of the driver IC that drives the optical pickup actuator may be stopped or the operation of the optical pickup actuator may be stopped. Also, as another example, the operation of an equalizer filter of a focus loop and a tracking loop of the optical pickup actuator may be stopped.

Each of the steps included in the optical pickup actuator protection method shown in FIG. 2 can be converted to an executable program. A computer or controller can be used to protect the optical pickup actuator by executing the program. A variety of recording media, e.g., a floppy disk, an optical disk, or a magnetic tape, may be used to store the program.

FIG. 3 illustrates a block diagram of a circuit for protecting an optical pickup actuator according to another embodiment of the present invention. Referring to FIG. 3, an optical pickup actuator protection circuit 30 may include an abnormal control signal generation block 31 and a protection determination block 39.

The abnormal control signal generation block 31 may generate the abnormal control signal CON using the focus error signal FES and the tracking error signal TES. Whether the focusing operation and the tracking operation are normally performed may be determined through the voltage level or waveform of the generated abnormal control signal CON.

Instead of the focus error signal FES and the tracking error signal TES, any type of signal used to control the focus and/or tracking can be used to generate the abnormal control signal CON. For example, the abnormal control signal CON may be generated using a focusing control signal FCS generated based on the focus error signal FES and a tracking control signal TCS generated based on the tracking error signal TES.

The protection determination block 39 may generate the protection command signal COMMAND by determining whether the focusing and tracking operations may electrically damage to the optical pickup actuator, and may include a first determination block 32, a second determination block 33, and a protection command signal generation block 34. The electrical damage refers to a case in which the time period in which the absolute value |V_{CON}| of the voltage level of the abnormal control signal CON is greater than the detection voltage level |V_{T}| is longer than the detection time range T_{W}. The detection voltage level V_{T} is the minimum voltage level to detect a case in which focusing and tracking are abnormally performed. The detection time range T_{W} is the minimum time interval to detect duration time in which focusing and tracking are abnormally performed.

The first determination block 32 may output a first determination signal D1 by determining whether the absolute value |V_{CON}| of the voltage level of the abnormal control signal CON is greater than the detection voltage level |V_{T}| of the detection voltage level. The second determination block 33 may output a second determination signal D2 by determining whether the time period T_{CON} in which the absolute value |V_{CON}| of the voltage level of the abnormal control signal CON exceeds the detection voltage level |V_{T}| of the detection voltage level exceeds the detection time range T_{W}.

The protection command signal generation block 34 may output the protection command signal COMMAND using the first determination signal D1 and the second determination signal D2. The protection command signal generation block 34 may be replaced by an AND gate, which logically multiplies the first determination signal D1 and the second determination signal D2 and outputs the protection command signal.

The detection voltage level V_{T} and the detection time range T_{W} may be stored in a storage device (not shown) capable of inputting and outputting. A register, which can be accessed by a user outside the system, may be used as the storage device. In some cases, a non-volatile memory may be used therefor.

FIG. 4 illustrates a block diagram of an application circuit using the optical pickup actuator protection circuit according to an embodiment of the present invention. Referring to FIG. 4, an application circuit 40 may include a digital signal processor (DSP) 41, a protection circuit 30, and a driver IC 43.

The DSP 41 may generate the focus error signal FES and the tracking error signal TES using a picked-up radio frequency (RF) output. The protection circuit 30 may generate the protection command signal COMMAND using the focus error signal FES and the tracking error signal TES. The driver IC 43, in response to the protection command signal COMMAND, may output the focus control signal FCS and the tracking control signal TCS for controlling the operation of the optical pickup actuator (not shown).

FIG. 5 illustrates a block diagram of an application circuit using the optical pickup actuator protection circuit according to another embodiment of the present invention. Referring to FIG. 5, an application circuit 50 may include a digital signal processor (DSP) 51, the protection circuit 30, and a driver IC 53.

The DSP 51 may generate the focus error signal FES and the tracking error signal TES using a picked-up radio frequency (RF) output. The driver IC 53 may generate the focus control signal FCS and the tracking control signal TCS using the focus error signal FES, the tracking error signal TES, and the protection command signal COMMAND. The protection circuit 30 may generate the protection command signal COMMAND using the focus error signal FES and the tracking error signal TES.

In FIGS. 4 and 5, the control signals FCS and TCS output by the driver ICs 43 and 53 using the protection command signal COMMAND may cease the operation of the optical pickup actuator or the driver ICs 43 and 53 to prevent the damage of the coil of the optical pickup actuator.

As described above, in the method, circuit, and recording medium for protecting an optical pickup actuator according to embodiments of the present invention, an appropriate action may be taken by detecting the flow of excessive current in the coil of the optical pickup actuator for an excessive time. Also, since a user can arbitrarily control detection conditions, a variety of protection conditions may be set according to the environment in which the optical pickup actuator is used.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for protecting an optical pickup actuator, the method comprising:
generating an abnormal control signal using signals controlling focusing and tracking of the optical pickup actuator; and
generating a protection command signal using the abnormal control signal, the protection command signal instructing protection of the optical pickup actuator by determining whether control of focusing and tracking of the optical pickup actuator is normal.

2. The method as claimed in claim 1, wherein a focus error signal and a tracking error signal are used for the generation of the abnormal control signal.

3. The method as claimed in claim 1, wherein a focus control signal generated from a focus error signal and a tracking control signal generated from a tracking error signal are used for the generation of the abnormal control signal.

4. The method as claimed in claim 1, wherein generating a protection command signal comprises:
comparing an absolute value of a voltage level of the abnormal control signal with an absolute value of a detection voltage level, wherein the detection voltage level indicates a minimum voltage level to detect a case in which focusing operation and tracking operation is abnormal; and
comparing a duration time which the absolute value of the voltage level of the abnormal control signal is greater than the absolute value of the detection voltage level with a detection time range, wherein the detection time range indicates a minimum time interval to detect a case in which abnormal operation damages the optical pickup actuator.

5. The method as claimed in claim 4, further comprising outputting the protection command signal when the duration time exceeds the detection time range.

6. The method as claimed in claim 5, further comprising controlling the abnormal operation of the optical pickup actuator using the protection command signal.

7. The method as claimed in claim 6, wherein controlling the abnormal operation of the optical pickup actuator comprises cutting off current flowing in a coil of the optical pickup actuator.

8. The method as claimed in claim 6, wherein controlling the abnormal operation of the optical pickup actuator comprises stopping operation of a drive circuit for the optical pickup actuator or the operation of the optical pickup actuator.

9. The method as claimed in claim 6, wherein controlling the abnormal operation of the optical pickup actuator comprises stopping the operation of an equalizer filter of a focus loop and a tracking loop of the optical pickup actuator.

10. The method as claimed in claim 5, wherein the detection voltage level and the detection time range are stored in a storage device capable of inputting and outputting.

11. The method as claimed in claim 10, wherein the storage device comprises at least one register.

12. The method as claimed in claim 10, wherein the storage device comprises a non-volatile memory device.

13. The method as claimed in claim 4, further comprising inputting the detection voltage level and the detection time range.

14. A computer-readable recording medium containing a program to be processed by a computer or a controller, the program performs following functions of:
generating an abnormal control signal using signals used to control focusing and tracking of an optical pickup actuator;
determining whether an absolute value of a voltage level of the abnormal control signal is greater than an absolute value of a detection voltage level;
determining whether a duration time which the absolute value of the voltage level of the abnormal control signal is greater than the absolute value of the detection voltage level exceeds a detection time range; and
generating a signal to instruct protection of the optical pickup actuator when the duration time exceeds the detection time range.

15. A circuit for protecting an optical pickup actuator, the circuit comprising:
an abnormal control signal generation unit which generates an abnormal control signal using signals used to control focusing and tracking of the optical pickup actuator; and
a protection determination unit which generates a protection command signal that instructs protection of the optical pickup actuator by determining whether focusing operation and tracking operation of the optical pickup actuator is normal, using the abnormal control signal.

16. The circuit as claimed in claim 15, wherein the abnormal control signal is generated using a focus error signal and a tracking error signal.

17. The circuit as claimed in claim 15, wherein the abnormal control signal is generated using a focusing control signal generated from a focus error signal and a tracking control signal generated from a tracking error signal.

18. The circuit as claimed in claim 15, wherein the protection determination unit comprises:
a first determination unit outputting a first determination signal by determining whether an absolute value of a voltage level of the abnormal control signal is greater than an absolute value of a detection voltage level;
a second determination unit outputting a second determination signal by determining whether a duration time which the absolute value of the voltage level of the abnormal control signal is greater than the absolute value of the detection voltage level exceeds the detection time range; and
a protection command signal generation unit outputting the protection command signal using the first determination signal and the second determination signal.

19. The circuit as claimed in claim 18, wherein the protection command signal generation unit comprises an AND gate which outputs the protection command signal by logically ANDing the first determination signal with the second determination signal.

20. The circuit as claimed in claim 15, further comprising a storage device capable of inputting and outputting, the storage device storing the detection voltage level and the detection time range.

21. The circuit as claimed in claim 20, wherein the storage device comprises at least one register.

22. The circuit as claimed in claim 20, wherein the storage device comprises a non-volatile memory device.
